(19) United States
(12) Patent Application Publication
(10) Pub. No.: US 2016/0107579 A1
(43) Pub. Date: Apr. 21, 2016

(54) METHOD AND APPARATUS FOR CONTROLLING VEHICLE EXTERIOR MIRRORS

(71) Applicant: GM GLOBAL TECHNOLOGY OPERATIONS LLC, Detroit, MI (US)

(72) Inventor: James F. Quinn, Troy, MI (US)

(21) Appl. No.: 14/518,227

(22) Filed: Oct. 20, 2014

(51) Int. Cl. B60R 1/074; B60R 1/12

(52) U.S. Cl. CPC B60R 1/074; B60R 1/12; B60R 2001/1284; B60R 2001/1223

(57) ABSTRACT

A method for controlling retractable exterior mirrors of a vehicle including an on-vehicle spatial monitoring system includes retracting one of the exterior mirrors when the on-vehicle spatial monitoring system indicates a likelihood of collision between the one of the retractable exterior mirrors and a remote object and extending the retracted exterior mirror when the on-vehicle spatial monitoring system indicates no likelihood of collision. One of the exterior mirrors retracts in response to opening an extra-vehicle door and extends in response to closing said extra-vehicle door.

### TECHNICAL FIELD

The present disclosure relates to exterior mirrors for vehicles.

### BACKGROUND

Vehicles include mirror assemblies that are externally mounted to the vehicle, and can be positioned such that a vehicle operator can observe areas at the side of and behind the vehicle. Mirror assemblies can protrude beyond the outer profile of the vehicle body, rendering them vulnerable to damage from proximal nearby obstructions during vehicle operation.

### SUMMARY

A method for controlling retractable exterior mirrors of a vehicle including an on-vehicle spatial monitoring system includes retracting one of the exterior mirrors when the on-vehicle spatial monitoring system indicates a likelihood of collision between the one of the retractable exterior mirrors and a remote object and extending the retracted exterior mirror when the on-vehicle spatial monitoring system indicates no likelihood of collision. One of the exterior mirrors retracts in response to opening an extra-vehicle door and extends in response to closing said extra-vehicle door.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a plan view of a vehicle including a controller, a spatial monitoring system and retractable exterior mirrors, in accordance with the disclosure; and

FIGS. 2-1 through 2-4 schematically show elements of a mirror retraction/extension routine to automatically retract vehicle exterior mirrors and automatically extend the retracted exterior mirrors, in accordance with the disclosure.

### DETAILED DESCRIPTION

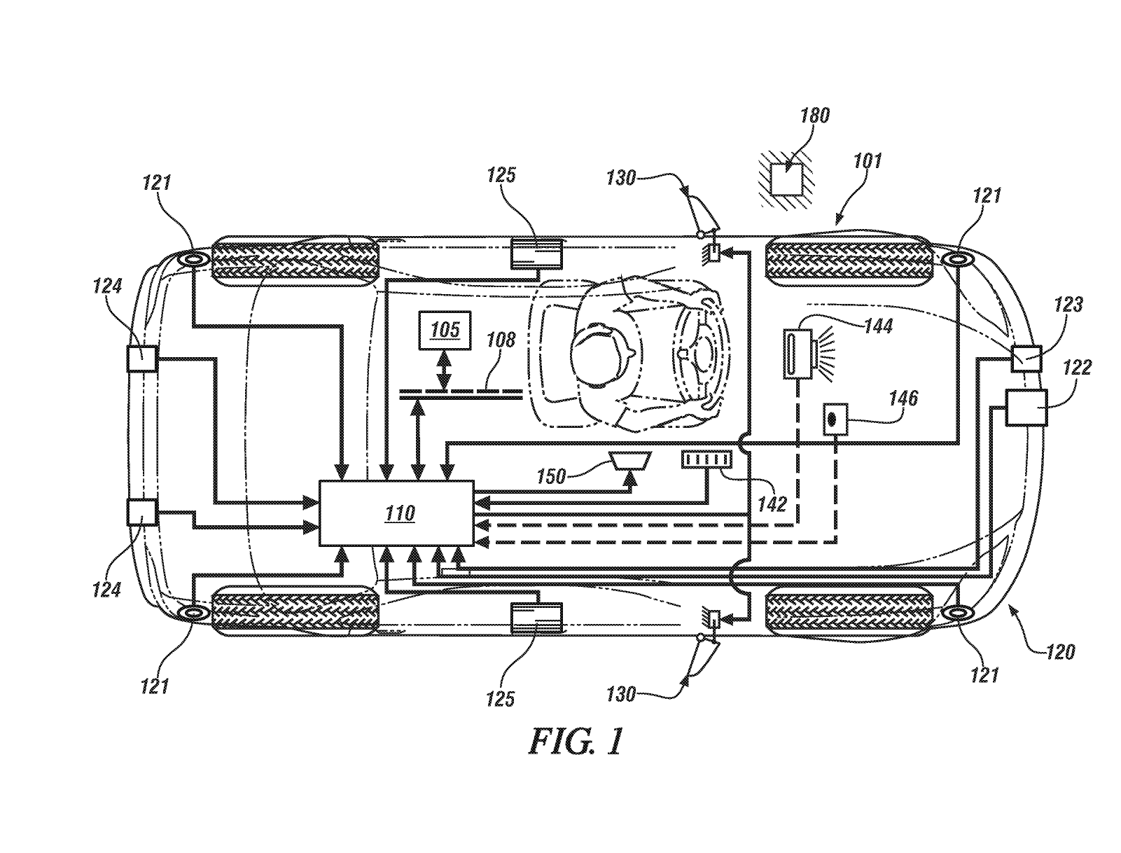

Referring now to the drawings, wherein the depictions are for the purpose of illustrating certain exemplary embodiments only and not for the purpose of limiting the same, FIG. 1 schematically shows a plan view of a vehicle 101 including a controller 105, a spatial monitoring system 120 and retractable exterior mirrors 130 that is configured to implement the concepts described herein. The vehicle 101 is a four-wheel ground vehicle for conveying one or more passengers and is equipped with a propulsion system, although the concepts described herein apply to other vehicles.

The retractable exterior mirrors 130 are side-view mirrors that pivotably or otherwise mount on an exterior door frame or body panel of the driver's door and the front passenger door of the vehicle 101. A controllable actuator, e.g., a linear solenoid couples to each of the mirrors. When controlled in a first position, the actuator positions each exterior mirror 130 in an extended position, thus rendering it viewable and useable by the vehicle operator. When controlled in a second position, the actuator positions the exterior mirror 130 in a retracted position, thus reducing the vehicle width in a lateral direction but rendering the exterior mirror 130 unusable by the vehicle operator for its intended purpose. Other controllable mechanisms for retracting and extending the exterior mirrors 130 may be employed within the scope of this disclosure.

The spatial monitoring system 120 includes a mirror controller 110 that signally connects to one or a plurality of spatial monitoring sensor(s) and operatively connects to the retractable exterior mirrors 130. The spatial monitoring system 120 monitors and evaluates input signals from the spatial monitoring sensor(s) to detect and locate a remote object 180 proximal to the vehicle 101. The mirror controller 110 executes control routines to monitor and detect a remote object 180 proximal to a portion of the vehicle 101 and executes control routines to retract and extend the retractable exterior mirror(s) 130 based thereon, with exemplary control routines described herein.

One or a plurality of spatial monitoring sensor(s) can be placed at various locations on the vehicle 101 to effect monitoring of exterior space to detect a remote object 180, e.g., a vehicle and other remote objects proximal to the vehicle 101. Each spatial monitoring sensor generates a digital signal that is communicated to mirror controller 110 representing the exterior space including the presence of remote object 180. Spatial monitoring sensors may be located in one or a plurality of on-vehicle positions, including one or more of front and rear corner sensors 121, a frontward sensor 122, rearward sensors 124 and left and right side sensors 125. The spatial monitoring sensors may also include a front radar sensor 122 and a camera 123, although the disclosure is not so limited. The frontward sensor 122 preferably includes object detection in front of the vehicle 101. The front corner sensors 121 preferably include short-range devices to monitor a region in front of the vehicle 101, e.g., radar sensors having a 60° field of view angle and 40 m detection range in one embodiment. Similarly, the rear corner sensors 121 preferably include short-range devices to monitor the region to the rear of the vehicle 101, e.g., radar sensors each having a 60° field of view angle and 40 m detection range in one embodiment. The side sensors 125 and rear sensors 124 also preferably include short-range devices to monitor oncoming traffic beside and behind the vehicle 101, each having a 60° field of view angle and 40 m detection range in one embodiment. The descriptions of the locations of the spatial monitoring sensor(s) is illustrative.

The spatial monitoring sensor(s) can include any one of a plurality of object-locating sensing devices including range sensors, such as FM-CW (Frequency Modulated Continuous Wave) radars, pulse and FSK (Frequency Shift Keying) radars, and Lidar (Light Detection and Ranging) devices, and ultrasonic devices which rely upon effects such as Doppler-effect measurements to locate a remote object. The possible object-locating devices include charged-coupled devices (CCD) or complementary metal oxide semi-conductor (CMOS) video image sensors, and other known camera/video image processors which utilize digital photographic methods to view a remote object. Such sensing systems are employed for detecting and locating objects in automotive applications and are useable with other on-vehicle control systems including adaptive cruise control, collision avoidance, pre-crash safety, and side-object detection.

The spatial monitoring sensor(s) are preferably positioned within the vehicle 101 in relatively unobstructed positions. Each of these sensors provides an estimate of actual location or condition of remote object 180 when present, wherein said estimate includes an estimated position and a standard deviation. As such, sensory detection and measurement of object locations and conditions may be referred to as estimates. A spatial monitoring sensor can be employed to estimate a distance between remote object 180 and a specific location on the vehicle 101 such as an exterior mirror, including estimating a lateral distance for purposes of determining likelihood of a collision between the remote object 180 and the vehicle 101. It is further appreciated that the characteristics of these sensors are complementary, in that some may be more reliable in estimating certain parameters than others. Sensors can have different operating ranges and angular coverages capable of estimating different parameters within their operating ranges. For example, radar sensors can usually estimate range, range rate and azimuth location of an object. A camera with a vision processor is capable of estimating a shape and azimuth position of the remote object 180. Scanning type lidar sensors perform efficiently and accurately with respect to estimating range, and azimuth position. Ultrasonic sensors are capable of estimating range to the remote object 180, from which a controller can estimate a distance between the remote object and a specific location on the vehicle 101 such as one of the exterior mirrors 130. It is appreciated that the performance of each sensor technology is affected by differing environmental conditions.

The remote object 180 can be stationary, i.e., fixed at a geographical location, or mobile. Examples of a stationary object remote from the vehicle 101 include a doorframe for an extra-vehicle access door, another vehicle in a parked state, and a stanchion at a car wash facility. An extra-vehicle access door can include any moveable device that controls access to a location, such as a garage door or a gate for a fenced area. In one embodiment a remotely controllable opening device, e.g., an electric motor, controls opening and closing of an extra-vehicle door. The remote object 180 is said to be proximal to the vehicle 101 when the remote object 180 can be detected by one or more spatial monitoring sensor(s).

The controller 105 signally connects to various vehicle systems via a communications link 108 to monitor inputs from various sensing systems and execute algorithms to control vehicle actuators in response to operator commands, including through the mirror controller 110. Operator commands are input through a plurality of operator input devices, including an ignition key or functional equivalent, an accelerator pedal, a brake pedal, a transmission range selector (PRNDL) 142 and others without limitation. In one embodiment, an operator provides commands to the controller 105 through an operator interface device 146, including one or more of a manipulable button, a touchscreen, a voice-activated control mechanism or another suitable interface device. Such operator commands include an override command to interrupt and override an automatic mirror retraction command or an automatic mirror extension command. A remote garage door opener 144 may be directly integrated into the vehicle system or, alternatively may be monitored by a vehicle system. Monitored vehicle parameters include vehicle speed and direction of travel. The controller 105 is shown as a single discrete element for ease of description, but may include a plurality of discrete controllers that are signally interconnected. Vehicle functions include, by way of example, powertrain operation, including cruise control system for controlling vehicle speed and acceleration, vehicle suspension/ride and handling, and other functions without limitation. Another vehicle system includes an audio speaker 150 to generate an audible tone, e.g., via an infotainment system. Vehicle control functions performed by the controller 105 may be executed using one or more devices, e.g., implemented as algorithmic code, predetermined calibrations, hardware, and/or application-specific integrated circuitry (ASIC).

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated memory and storage devices (read only, programmable read only, random access, hard drive, etc.) executing one or more software or firmware programs or routines, combinational logic circuit(s), input/output circuit(s) and devices, signal conditioning and buffer circuitry and other components to provide a described functionality. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals, for example each 100 microseconds or 3.125, 6.25, 12.5, 25 and 100 milliseconds during ongoing operation. Alternatively, routines may be executed in response to occurrence of an event. Communications between various controllers, actuators and sensors may be accomplished using a direct wired link, a networked communications bus link, a wireless link or any another suitable communications link.

FIGS. 2-1 through 2-4 schematically show elements of a mirror retraction/extension routine 200 for controlling an embodiment of the vehicle 101 described in FIG. 1 including the retractable exterior mirror(s) 130 and the spatial monitoring system 120. The mirror retraction/extension routine 200 operates to automatically retract one or a plurality of vehicle exterior mirrors when there is a likelihood of a collision with a remote object and to automatically extend the retracted exterior mirrors when the likelihood of a collision has passed. This includes executing a portion of the mirror retraction/extension routine 200 when the vehicle is entering or exiting a garage, including in response to an operator command to activate an automatic garage door opener. Table 1 is provided as a key wherein the numerically labeled blocks and the corresponding functions are set forth as follows, corresponding to a first portion of the mirror retraction/extension routine 200.

TABLE 1

| BLOCK | BLOCK CONTENTS |
|---|---|
| 201 | Execute |
| 202 | Is vehicle in propulsion gear? |
| 203 | Is vehicle speed less than threshold speed? |
| 204 | Are mirrors currently retracted? |
| 205 | Sense proximal remote object? |
| 206 | Command mirror retraction and sound tone |
| 207 | Execute override of commanded mirror |
| | retraction? |
| 208 | Monitor system |

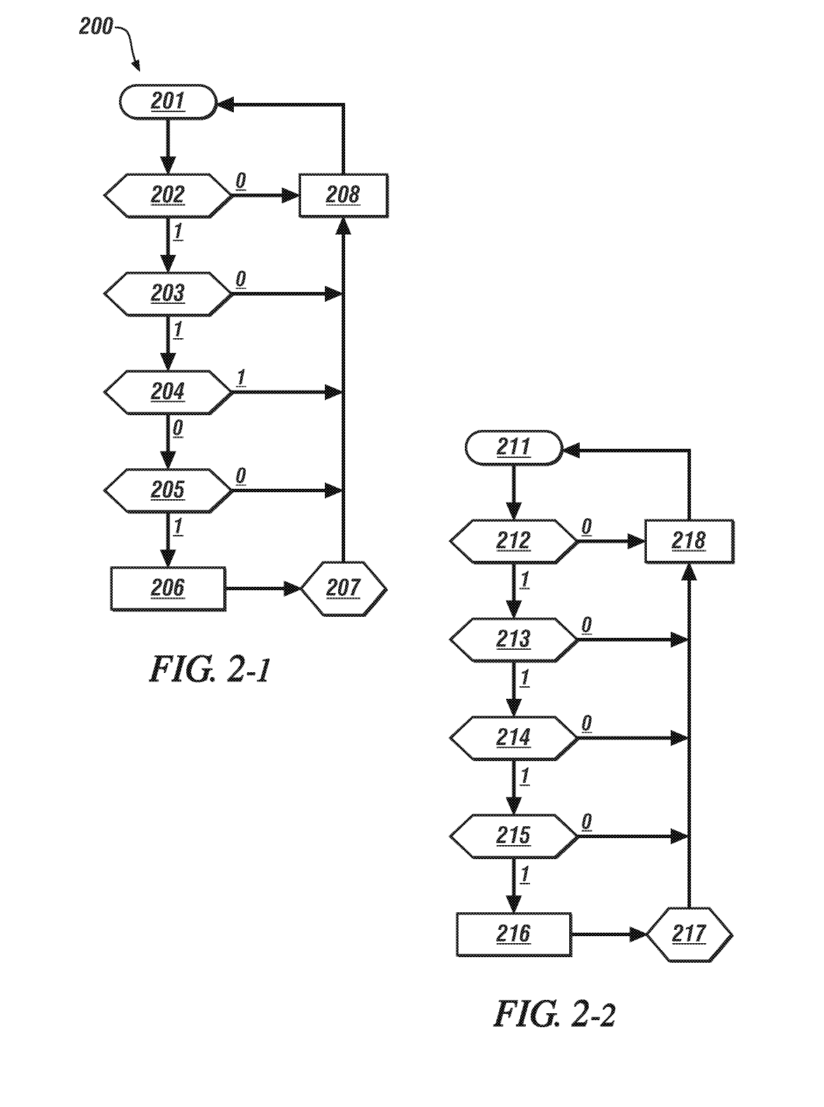

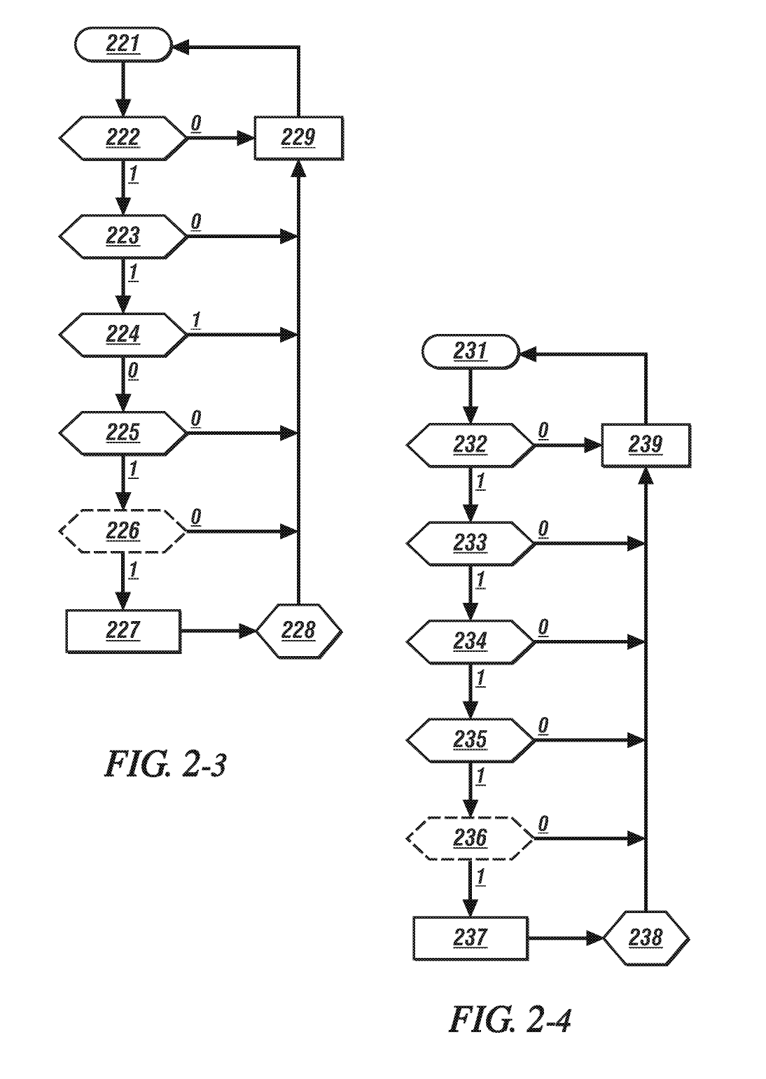

FIG. 2-1 relates to an operation to decide to retract the exterior mirrors when the vehicle approaches a remote object at a low vehicle speed with the exterior mirrors in extended positions wherein there is a likelihood that one of the exterior mirrors will collide with the remote object based upon input from the spatial monitoring system 120. The operation includes, in response to an execution command (201), determining that operation of the vehicle is commanded in one of the propulsion gear ranges, i.e., in one of a forward gear, e.g., Drive (D) or reverse (R) (202)(1), determining that the vehicle is operating below a threshold speed, e.g., less than 3 MPH (203)(1), and determining that the exterior mirrors are not presently extended (204)(0). The foregoing conditions are shown sequentially, but it is appreciated that such conditions may be determined in any suitable order of execution including coincident execution. When all the foregoing conditions are simultaneously met, the control system commands retraction of one or both the exterior mirrors and sounds an audible tone or otherwise notifies the vehicle operator (206) when the spatial monitoring system indicates that a remote object is proximal to one or both sides of the vehicle (205)(1). Sounding an audible tone is one of several methodologies that can be employed to notify the vehicle operator of a pending retraction of the mirror(s). Other methodologies to notify the vehicle operator of a pending retraction of the mirror(s) include visual display(s) through one or more user interface(s) and audible statements through an infotainment system, by way of example. Preferably, the spatial monitoring system is tuned to indicate that a remote object is proximal to one side of the vehicle under low speed conditions when the remote object is within an envelope around the vehicle that is defined by the outer vehicle dimensions including the exterior mirrors in their extended positions, thus indicating a likelihood of collision between one of the exterior mirrors and the remote object if the vehicle continues on its trajectory. As such, the control system preferably commands retraction of only one of the exterior mirrors when the spatial monitoring system indicates that the remote object is proximal to one side of the vehicle, and commands retraction of both of the exterior mirrors when the spatial monitoring system indicates that the remote object is proximal to both sides of the vehicle. The vehicle operator is afforded an opportunity to interrupt and override the commanded retraction of the one or both the exterior mirrors via input to the operator interface device 146 (207), in which case the system monitoring continues without retracting the exterior mirror (208). When any of the foregoing conditions are not met (202)(0), (203)(0), (204)(1) or (205)(0), system monitoring continues without retracting the exterior mirror (208).

FIG. 2-2 is a portion of the mirror retraction/extension routine 200 that relates to an operation to decide to extend refracted exterior mirror(s) when the vehicle operates at a low vehicle speed with the exterior mirrors in retracted positions. This portion of the mirror retraction/extension routine 200 can execute during a vehicle key-on cycle subsequent to a vehicle key-on cycle in which the exterior mirrors are retracted, including when one or both of the exterior mirrors have been previously manually retracted or retracted in response to an operator command. Table 2 is provided as a key wherein the numerically labeled blocks and the corresponding functions are set forth as follows, corresponding to the mirror retraction/extension routine 200.

TABLE 2

| BLOCK | BLOCK CONTENTS |
|---|---|
| 211 | Execute |
| 212 | Are mirrors currently retracted? |
| 213 | Is vehicle in propulsion gear? |
| 214 | Is vehicle speed less than threshold speed? |
| 215 | Sense proximal remote object? |
| 216 | Command mirror extension and sound tone |
| 217 | Execute override of commanded mirror |
| | extension? |
| 218 | Monitor system |

The operation includes, in response to an execution command (211), determining that one or both the exterior mirrors are presently retracted (212)(1), determining that operation of the vehicle is commanded in one of the propulsion gear ranges, i.e., in one of a forward gear, e.g., Drive (D) or reverse (R) (213)(1), and determining that the vehicle is operating below a threshold speed, e.g., less than 3 MPH (214)(1). The foregoing conditions are shown sequentially, but it is appreciated that such conditions may be determined in any suitable order of execution including coincident execution. When all the foregoing conditions are simultaneously met, the control system commands extending the retracted exterior mirror(s) and sounds an audible tone (216) when the spatial monitoring system indicates that a previously detected remote object is no longer proximal to the vehicle (215)(1). The vehicle operator is afforded an opportunity to interrupt and override the commanded extension of the one or both the exterior mirrors via input to the operator interface device 146 (217), in which case the system monitoring continues without extending the exterior mirror(s) (218). When any of the foregoing conditions are not met (212)(0), (213)(0), (214)(0) or (215)(0), system monitoring continues with the exterior mirror(s) in the retracted position (218) due to the likelihood of collision between one of the exterior mirrors and the remote object while the vehicle continues on its trajectory.

FIG. 2-3 is a portion of the mirror retraction/extension routine 200 that relates to an operation to retract one or both of the exterior mirrors when the vehicle approaches a remote object at a low vehicle speed with the exterior mirrors in extended positions wherein an operator remotely commands activating an automatic garage door opener to open a garage door, thus increasing a likelihood that one of the exterior mirrors will collide with the remote object, i.e., the garage door frame. Table 3 is provided as a key wherein the numerically labeled blocks and the corresponding functions are set forth as follows, corresponding to the mirror retraction/extension routine 200.

TABLE 3

| BLOCK | BLOCK CONTENTS |
|---|---|
| 221 | Execute |
| 222 | Is vehicle in propulsion gear? |
| 223 | Is vehicle speed less than threshold speed? |
| 224 | Are exterior mirrors extended? |
| 225 | Has obstruction been sensed? |
| 226 | Is garage door opener remotely activated? |
| 227 | Command mirror retraction and sound tone |
| 228 | Execute override of commanded mirror |
| | retraction? |
| 229 | Monitor system |

The operation includes, in response to an execution command (221), determining that the operation of the vehicle is commanded in one of the propulsion gear ranges, i.e., in one of a forward gear, e.g., Drive (D) or reverse (R) (222)(1), determining that the vehicle is operating below a threshold speed, e.g., less than 3 MPH (223)(1) and determining that the exterior mirrors are presently extended (224)(1). In an embodiment employing a spatial monitoring system, the system determines whether a remote object is proximal to one or both sides of the vehicle, i.e., whether an obstruction has been sensed (225)(1). The foregoing conditions are shown sequentially, but it is appreciated that such conditions may be determined in any suitable order of execution including coincident execution. When all the foregoing conditions are simultaneously met, the control system commands retraction of one or both the exterior mirrors and sounds an audible tone (227) when the garage door opener is remotely activated to open the garage door, such as by the vehicle operator or through the vehicle control system (226)(1). When any of the foregoing conditions are not met (222)(0), (223)(0), (224)(0), (225)(0) or (226)(0), system monitoring continues with the exterior mirrors in the extended position (229). The vehicle operator is afforded an opportunity to interrupt and override the commanded retraction of the one or both the exterior mirrors via input to the operator interface device 146 (228), in which case the system monitoring also continues (229).

FIG. 2-4 is a portion of the mirror retraction/extension routine 200 that relates to an operation to decide to extend the exterior mirrors when the vehicle operates at a low vehicle speed with one or both of the exterior mirrors in retracted positions and the operator remotely commands activating the automatic garage door opener to close the garage door. Table 4 is provided as a key wherein the numerically labeled blocks and the corresponding functions are set forth as follows, corresponding to the mirror retraction/extension routine 200.

TABLE 4

| BLOCK | BLOCK CONTENTS |
|---|---|
| 231 | Execute |
| 232 | Are exterior mirrors retracted? |
| 233 | Is vehicle in propulsion gear? |
| 234 | Is vehicle speed less than threshold speed? |
| 235 | Has obstruction been sensed? |
| 236 | Is garage door opener remotely activated? |
| 237 | Command extension of mirrors and sound |
| | tone |
| 238 | Execute override of commanded mirror |
| | extension? |
| 239 | Monitor system |

The operation includes, in response to an execution command (231), determining that the exterior mirrors are presently retracted (232)(1), determining that the operation of the vehicle is commanded in one of the propulsion gear ranges, i.e., in one of a forward gear, e.g., Drive (D) or reverse (R) (233)(1), determining that the vehicle is operating below a threshold speed, e.g., less than 3 MPH (234)(1) and in one embodiment determining that no obstruction is presently sensed (235)(1). The foregoing conditions are shown sequentially, but it is appreciated that such conditions may be determined in any suitable order of execution including coincident execution. When all the foregoing conditions are simultaneously met, the control system commands extension of the exterior mirrors and sounds an audible tone (237) when the garage door opener is remotely activated to close the garage door, such as by the vehicle operator or through the vehicle control system (236)(1). When any of the foregoing conditions are not met (232)(0), (233)(0), (234)(0), (235)(0), (236)(0), system monitoring continues with the exterior mirrors in the retracted position (239). The vehicle operator is afforded an opportunity to interrupt and override the commanded extension of the one or both the exterior mirrors via input to the operator interface device 146 (238), in which case the system monitoring also continues (239).

Thus, vehicles that have protruding exterior rear view mirrors are vulnerable to damage and to causing damage from nearby obstructions, for example, when pulling the vehicle into or out of a small garage, a narrow parking space or a carwash. To prevent such damage the concepts described herein can be employed to automatically retract the mirrors when a garage door opener is activated or when a proximity sensor indicates a high likelihood of striking an obstruction. Such a system reduces driver workload of having to manually retract mirrors, prevents damage to vehicle exterior and prevents damage to surrounding property. The system also determines when it is safe to unfold the mirrors. The operator is given the option to completely deactivate the mirror retraction/extension routine 200 under all operating conditions.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for controlling retractable exterior mirrors of a vehicle including an on-vehicle spatial monitoring system, comprising:
retracting, by a controller, one of the exterior mirrors when the on-vehicle spatial monitoring system indicates a likelihood of collision between the one of the exterior mirrors and a remote object;
extending the one of the exterior mirrors when the on-vehicle spatial monitoring system indicates no likelihood of collision between the retracted exterior mirror and the remote object;
retracting one of the exterior mirrors in response to opening an extra-vehicle door; and
extending the retracted exterior mirror in response to closing said extra-vehicle door.

2. The method of claim 1, further comprising retracting the one of the exterior mirrors only when the on-vehicle spatial monitoring system indicates the likelihood of collision between one of the retractable exterior mirrors and the remote object with the vehicle operating at low speed.

3. The method of claim 1, further comprising overriding the retracting of the one of the exterior mirrors.

4. The method of claim 1, further comprising extending the one of the exterior mirrors when the on-vehicle spatial monitoring system indicates no likelihood of collision between the retracted exterior mirror and the remote object only when the vehicle is operating at low speed.

5. The method of claim 1, further comprising overriding the extending of the one of the exterior mirrors.

6. The method of claim 1, wherein retracting one of the exterior mirrors in response to opening an extra-vehicle door further comprises retracting one of the exterior mirrors in response to the opening of the extra-vehicle door when an on-vehicle spatial monitoring system indicates a likelihood of collision between the one of the exterior mirrors and a remote object.

7. The method of claim 1, wherein extending the retracted exterior mirrors in response to closing said extra-vehicle door further comprises extending the retracted exterior mirrors in response to closing said extra-vehicle door only when an on-vehicle spatial monitoring system indicates no likelihood of collision between one of the exterior mirrors and a remote object.

8. The method of claim 1, wherein the on-vehicle spatial monitoring system comprises an ultrasonic device configured to locate the remote object.

9. A method for controlling retractable exterior mirrors on a vehicle including an on-vehicle spatial monitoring system, comprising:
indicating, by the on-vehicle spatial monitoring system, an imminent collision between one of the exterior mirrors and a remote object during low-speed vehicle operation and retracting the one of the exterior mirrors in response to said indicating; and
extending the retracted one of the exterior mirrors when the on-vehicle spatial monitoring system discontinues indicating a likelihood of collision between the exterior mirrors in the extended state and the remote object.

10. The method of claim 9, further comprising retracting the exterior mirrors in response to opening an extra-vehicle access door; and
extending the exterior mirrors in response to closing said extra-vehicle access door.

11. The method of claim 9, further comprising:
retracting, by a controller, exterior mirrors when a likelihood of collision is indicated by the on-vehicle spatial monitoring system and subsequently extending the retracted exterior mirrors when no likelihood of collision is indicated by the on-vehicle spatial monitoring system; and
retracting the exterior mirrors in response to opening an extra-vehicle door and extending the retracted exterior mirrors in response to closing said extra-vehicle door.

12. The method of claim 11, further comprising retracting the exterior mirrors only when the on-vehicle spatial monitoring system indicates likelihood of collision between one of the retractable exterior mirrors and the remote object with the vehicle operating at low speed.

13. The method of claim 12, further comprising overriding the retracting of the one of the exterior mirrors.

14. The method of claim 12, further comprising overriding the extending of the one of the exterior mirrors.

15. A vehicle system, comprising:
retractable exterior mirrors;
an on-vehicle spatial monitoring system; and
a controller operative to:
retract one of the exterior mirrors when the on-vehicle spatial monitoring system indicates a likelihood of collision between the one of the exterior mirrors and a remote object;
extend the one of the exterior mirrors when the on-vehicle spatial monitoring system indicates no likelihood of collision between the retracted exterior mirror and the remote object;
retract one of the exterior mirrors responsive to opening an extra-vehicle door; and
extend the retracted exterior mirror responsive to closing said extra-vehicle door.

16. The vehicle system of claim 15, further comprising the controller operative to retract the exterior mirrors only when the on-vehicle spatial monitoring system indicates likelihood of collision between one of the retractable exterior mirrors and the remote object with the vehicle operating at low speed.

17. The vehicle system of claim 15, further comprising the controller operative to notify the vehicle operator of a pending retraction of one of the exterior mirrors.

18. The vehicle system of claim 17, further comprising the controller operative to override the retraction of one of the exterior mirrors responsive to an operator request.

19. The method of claim 15, wherein the on-vehicle spatial monitoring system comprises an ultrasonic device configured to locate the remote object.
